(19) United States
(12) Patent Application Publication
(10) Pub. No.: US 2015/0170585 A1
(43) Pub. Date: Jun. 18, 2015

(54) METHOD OF DRIVING A DISPLAY PANEL AND DISPLAY APPARATUS PERFORMING THE METHOD

(71) Applicant: Samsung Display Co., LTD., Yongin-City (KR)

(72) Inventors: Yong-Ju JEONG, Seoul (KR); Jae-Kook KIM, Asan-si (KR); Jeong-Jin PARK, Cheonan-si (KR); Seung-Woon SHIN, Asan-si (KR); Choong-Seob OH, Yongin-si (KR); Hyoung-Bin LIM, Asan-si (KR); Min-Sung CHOI, Cheonan-si (KR)

(73) Assignee: Samsung Display Co., LTD., Yongin-City (KR)

(21) Appl. No.: 14/256,837

(22) Filed: Apr. 18, 2014

(30) Foreign Application Priority Data
Dec. 12, 2013 (KR) 10-2013-0154910

(51) Int. Cl. G09G 3/36

(52) U.S. Cl. CPC G09G 3/3607; G09G 2320/0626; G09G 2300/0478

(57) ABSTRACT

A method of driving a display panel includes receiving a screen selection signal which is configured to select one of a first screen of the display panel and a second screen of the display panel opposite to the first screen, selecting one of first option data, which are configured to display a normal image on the first screen, and second option data, which are configured to display the normal image on the second screen, based on the screen selection signal and driving the display panel based on the selected one of the first option data and the second option data.

This application claims priority to Korean Patent Application No. 10-2013-0154910, filed on Dec. 12, 2013, and all the benefits accruing therefrom under 35 U.S.C. §119, the content of which in its entirety is herein incorporated by reference.

### BACKGROUND

1. Field

Exemplary embodiments of the invention relate to a method of driving a display panel and a display apparatus performing the method. More particularly, exemplary embodiments of the invention relate to a method of driving a display panel for improving display quality of a display apparatus, which may be a transparent display apparatus, and a display apparatus performing the method.

2. Description of the Related Art

In general, a flat panel display apparatus includes a liquid crystal display (“LCD”) apparatus. The LCD apparatus typically includes an LCD panel and a backlight unit.

The LCD panel typically includes a plurality of data lines, a plurality of gate lines crossing the data lines, and a plurality of pixels may be connected to the data lines and the gate lines.

The backlight unit may include a light-source and a reflecting plate, and thus light generated from the light-source is provided to the LCD panel by the reflecting plate.

The LCD apparatus typically has a front screen being transparent and a rear screen being opaque by the backlight unit such that a viewer may observe an image displayed on the front screen.

Currently, a transparent display apparatus has developed as the next generation display apparatus.

The transparent display apparatus may substitute for the plan display apparatus and may be utilized in various fields which are different to apply in the plan display apparatus.

The transparent display apparatus may not include the backlight unit, and the front and rear screens may be thereby transparent. Therefore, when the front screen displays a normal image, the viewer which is located a position facing to the rear screen, may observe an abnormal image on the rear screen.

When the transparent display apparatus displays a text image reversed from left and right, the text image on the front screen is observed normally, but the text image on the rear screen is observed abnormally.

### SUMMARY

Exemplary embodiments of the invention provide a method of driving a display panel for improving display quality of a transparent display apparatus including the display panel.

Exemplary embodiments of the invention provide a display apparatus performing the method.

According to an exemplary embodiment of the invention, a method of driving a display panel includes receiving a screen selection signal, which is configured to select one of a first screen of the display panel and a second screen of the display panel opposite to the first screen, selecting one of first option data, which are configured to display a normal image on the first screen, and second option data, which are configured to display the normal image on the second screen, based on the screen selection signal, and driving the display panel based on the selected one of the first option data and the second option data.

In an exemplary embodiment, first image data, which are applied to the display panel based on the first option data, may be opposite to second image data, which are applied to the display panel based on the second option data, with respect to left and right sides of the display panel.

In an exemplary embodiment, the method may further include generating the screen selection signal using a power-source signal of the display panel.

In an exemplary embodiment, the first screen of the display panel may display the normal image based on the screen selection signal in a low level, and the second screen of the display panel may display the normal image based on the screen selection signal in a high level.

In an exemplary embodiment, the method may further include resetting an operation of the display panel in response to a reset signal, when a level of the screen selection signal is changed.

In an exemplary embodiment, the method may further include providing the second screen of the display panel with light in response to the screen selection signal in the low level and providing the first screen of the display panel with the light in response to the screen selection signal in the high level.

According to an exemplary embodiment of the invention, a display apparatus includes a display panel including a first screen and a second screen opposite to the first screen, a storage part which stores first option data, which are configured to display a normal image on the first screen, and second option data, which are configured to display the normal image on the second screen, and a timing control part which receives a screen selection signal configured to select one of the first and second screens of the display panel and drives the display panel using one of the first option data and the second option data, where the one of the first option data and the second option data is selected based on the screen selection signal.

In an exemplary embodiment, the display apparatus may further include a data driving part configured to provide the display panel with image data, where the data driving part may provide the display panel with first image data based on the first option data and the display panel with second data based on the second option data, and the second data may be opposite to the first data with respect to left and right sides of the display panel.

In an exemplary embodiment, the display apparatus may further include a first input connector disposed at a first side portion of the display panel and configured to receive an external signal and a second input connector disposed at a second side portion of display panel opposite to the first side portion and configured to receive the external signal.

In an exemplary embodiment, one of the first and second input connectors may generate the screen selection signal using the external signal.

In an exemplary embodiment, the external signal may be a power-source signal.

In an exemplary embodiment, the screen selection signal may have a level substantially same as a level of the power-source signal.

In an exemplary embodiment, the screen selection signal may be received via a user interface.

In an exemplary embodiment, the first screen of the display panel may display the normal image in response to the screen selection signal in a low level, and the second screen of the display panel may display the normal image in response to the screen selection signal in a high level.

In an exemplary embodiment, the timing control part may reset an operation of the display panel in response to a reset signal, when a level of the screen selection signal is changed.

In an exemplary embodiment, the display apparatus may further include a first light-source module disposed adjacent to the second screen and configured to provide the second screen with light and a second light-source module disposed adjacent to the first screen and configured to provide the first screen with light.

In an exemplary embodiment, each of the first and second light-source modules may include a transparent light guide plate and a light-source disposed at an edge portion of the transparent light guide plate.

In an exemplary embodiment, the timing control part may be configured to control an operation of the first and second light-source modules based on the screen selection signal.

In an exemplary embodiment, the first light-source module may provide the second screen of the display panel with the light, when the first screen of the display panel displays the normal image.

In an exemplary embodiment, the second light-source module may provide the first screen of the display panel with the light, when the second screen of the display panel displays the normal image.

According to exemplary embodiments of the invention, the viewer may observe the normal image selectively displayed on front or rear screen of the transparent display apparatus, in which the front and rear screens are all transparent. Thus, in such embodiments, the display quality of the transparent display apparatus may be improved.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram illustrating an exemplary embodiment of a display apparatus, according to the invention;

FIG. 2 is a waveform diagram illustrating an exemplary embodiment of input and output signals corresponding to a front screen display mode of the display apparatus of FIG. 1;

FIG. 3 is a waveform diagram illustrating an exemplary embodiment of input and output signals corresponding to a rear screen display mode of the display apparatus of FIG. 1;

FIG. 4 is a plan view of an alternative exemplary embodiment of a display apparatus, according to the invention;

FIGS. 5A and 5B are conceptual diagrams illustrating an exemplary embodiment of an input connector of the display apparatus of FIG. 4;

FIG. 6 is a waveform diagram illustrating an exemplary embodiment of input and output signals of a display apparatus, according to the invention;

FIG. 7 is a block diagram illustrating another alternative exemplary embodiment of a display apparatus, according to the invention; and

FIG. 8 is a waveform diagram illustrating an exemplary embodiment of input and output signals of the display apparatus of FIG. 7.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, exemplary embodiments of the invention will be described in detail with reference to the accompanying drawings.

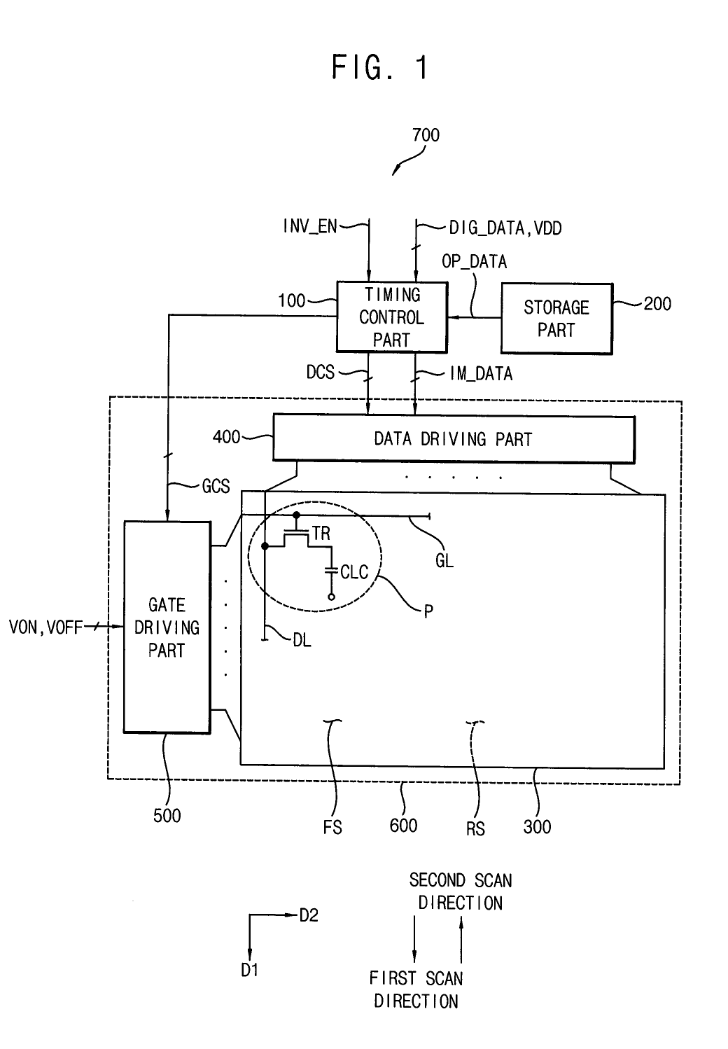

FIG. 1 is a block diagram illustrating an exemplary embodiment of a display apparatus, according to the invention.

Referring to FIG. 1, an exemplary embodiment of a display apparatus 700 includes a timing control part 100, a storage part 200 and a display module 600.

The timing control part 100 receives digital data DIG_DATA, which are image data, a power-source signal VDD and a screen selection signal INV_EN from an external system.

In an exemplary embodiment, the screen selection signal INV_EN is a signal for selecting one of a first screen (e.g., a front screen) FS of the display module 600 and a second screen (e.g., a rear screen) RS of the display module 600 opposite to the front screen FS to allow a normal image to be displayed on the front or rear screen FR or RS selected based on the screen selection signal INV_EN. Herein, the normal image may be an image predetermined to be displayed to a viewer based on the digital data DIG_DATA from the external system. In one exemplary embodiment, for example, when the screen selection signal INV_EN is in a low level LL, a front screen display mode, in which the normal image is displayed on the front screen FS, may be selected, and when the screen selection signal INV_EN is in a high level HL, a rear screen display mode, in which the normal image is displayed on the rear screen RS, may be selected. Thus, a viewer may observe the normal image displayed on the front screen FS of the display module 600 in the front screen display mode, and the viewer may observe the normal image displayed on the rear screen RS of the display module 600 in the rear screen display mode.

In an exemplary embodiment, the storage part 200 stores option data OP_DATA corresponding to a driving option item of the display module 600. In one exemplary embodiment, for example, the storage part 200 stores first option data corresponding to a front option item for displaying the normal image on the front screen FS of the display module 600 and second option data corresponding to a rear option item for displaying the normal image on the rear screen RS of the display module 600. In such an embodiment, the storage part 200 may store third option data corresponding to a forward direction mode, in which the normal image is displayed along a first scan direction, and fourth option data corresponding to a reverse direction mode, in which the normal image is displayed along a second scan direction opposite to the first scan direction.

The timing control part 100 generates a data control signal DCS and a gate control signal GCS which are configured to drive the display module 600 based on the option data OP_DATA selected by the screen selection signal INV_EN. In an exemplary embodiment, the timing control part 100 rearranges the image data (e.g., the digital data DIG_DATA) in accordance with a display mode based on the option data OP_DATA, and then provides the rearranged image data IM_DATA with the display module 600.

In one exemplary embodiment, for example, first image data in accordance with the first option data are applied to the display module 600 in the front screen display mode. In such an embodiment, second image data opposite to the first image data with respect to left and right side are applied to the display module 600 in the rear screen display mode.

The display module 600 includes a display panel 300, a data driving part 400 and a gate driving part 500. A front screen of the display panel 300 corresponds to the front screen FS of the display module 600 and a rear screen of the display panel 300 corresponds to the rear screen RS of the display module 600.

In an exemplary embodiment, the display module 600 may have the first and second screens FS and RS of a transparent type, and may not include a light-source unit which provides the display panel 300 with light.

The display panel 300 includes a plurality of data lines DL, a plurality of gate lines GL and a plurality of pixels P.

The data lines DL extend substantially in a first direction D1 and are arranged substantially in a second direction D2 crossing the first direction D1. The gate lines GL extend substantially in the second direction D2 and are arranged substantially in the first direction D1. The pixels P are arranged substantially in a matrix form. Each of the pixels P includes a switching element TR, which is connected to the data line DL and the gate line GL, and a liquid crystal capacitor CLC, which is connected to the switching element TR.

The data driving part 400 receives the data control signal DCS and the image data IM_DATA from the timing control part 100, converts the image data IM_DATA into a data signal of analog type based on the data control signal DCS and provides the data line DL with the data signal.

The gate driving part 500 receives the gate control signal GCS from the timing control part 100, generates a gate signal using or utilizing gate driving voltages VON and VOFF based on the gate control signal GCS and sequentially provides the gate lines GL with the gate signal.

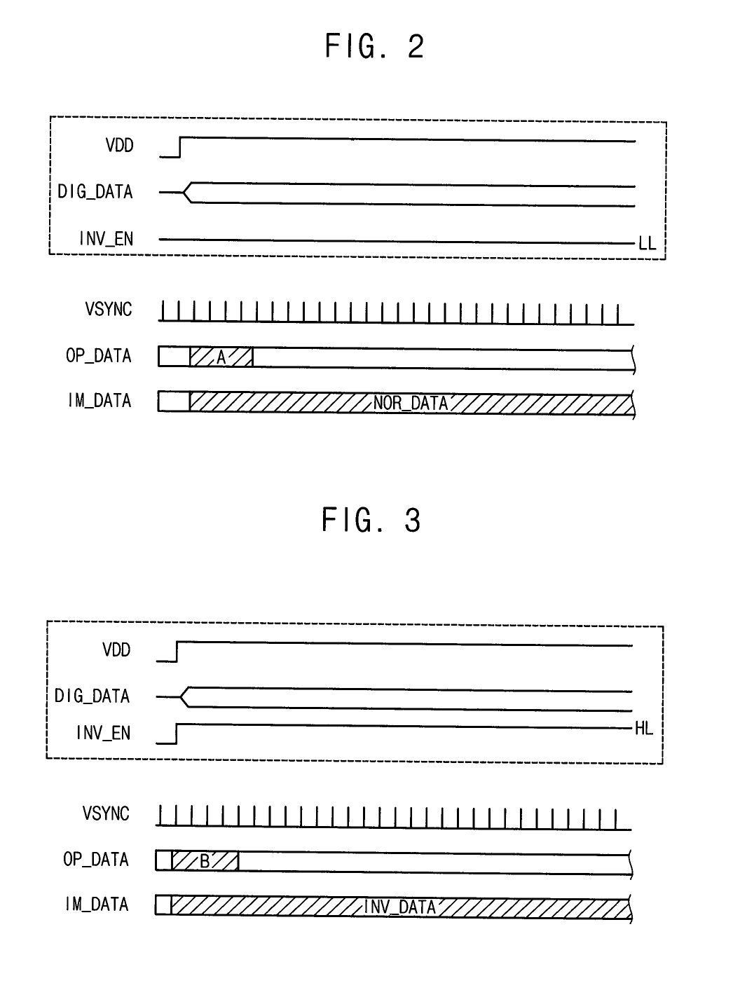

FIG. 2 is a waveform diagram illustrating an exemplary embodiment of input and output signals corresponding to a front screen display mode of the display apparatus of FIG. 1. FIG. 3 is a waveform diagram illustrating an exemplary embodiment of input and output signals corresponding to a rear screen display mode of the display apparatus of FIG. 1.

Referring to FIGS. 1 and 2, the timing control part 100 receives the digital data DIG_DATA, the power-source signal VDD and the screen selection signal NV_EN.

The timing control part 100 generates a vertical synchronization signal VSYNC. In one exemplary embodiment, for example, the timing control part 100 may generate the data control signal DCS and the gate control signal GCS based on the vertical synchronization signal VSYNC.

The timing control part 100 reads out the option data OP_DATA from the storage part 200 based on the screen selection signal INV_EN.

In an exemplary embodiment, as shown in FIG. 2, when the screen selection signal INV_EN is in a low level LL, the timing control part 100 reads out first option data A corresponding to the front screen display mode from the storage part 200.

In an exemplary embodiment, the timing control part 100 rearranges the digital data DIG_DATA into the image data IM_{—} DATA corresponding to the front screen display mode, e.g., first image data NOR_DATA, based on the first option data A, and provides the data driving part 400 with first image data NOR_DATA.

Therefore, in such an embodiment, an image is displayed on the front screen FS of the display panel 300 based on the first image data NOR_DATA such that the viewer may normally observe the image displayed on the front screen FS from a front view.

Referring to FIGS. 1 and 3, the timing control part 100 receives the digital data DIG_DATA, the power-source signal VDD and the screen selection signal INV_EN.

The timing control part 100 generates the vertical synchronization signal VSYNC, and then generates the data control signal DCS and the gate control signal GCS based on the vertical synchronization signal VSYNC.

The timing control part 100 reads out the option data OP_DATA from the storage part 200 based on the screen selection signal INV_EN.

In such an embodiment, as shown in FIG. 3, when the screen selection signal INV_EN is in a high level HL, the timing control part 100 reads out second option data B corresponding to the rear screen display mode from the storage part 200.

In an exemplary embodiment, the timing control part 100 rearranges the digital data DIG_DATA into the image data IM_{—} DATA corresponding to the rear screen display mode, e.g., second image data INV_DATA, based on the second option data B, and then outputs the second image data INV_DATA to the data driving part 400.

Therefore, in such an embodiment, the display panel 300 displays the image on the rear screen and thus the viewer may normally observe the image displayed on the rear screen from a rear view.

In an exemplary embodiment, the display module 600 is a transparent display panel and thus, the display module 600 may selectively display the image in a front screen display mode or a rear screen display mode.

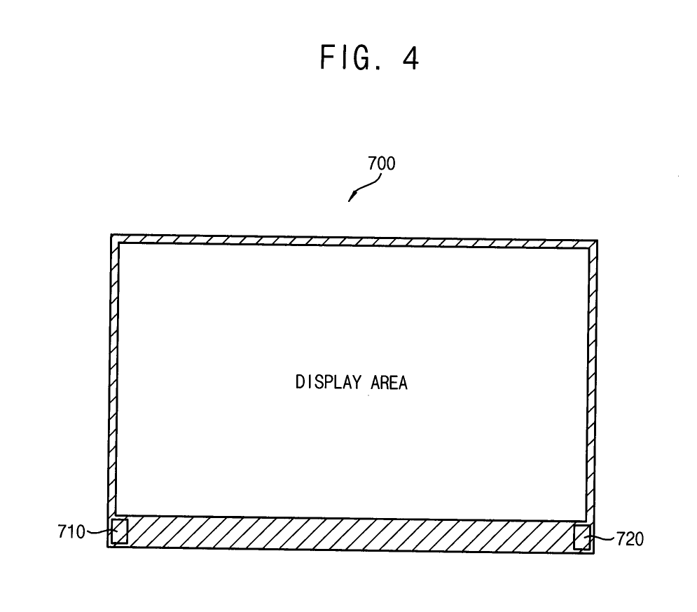

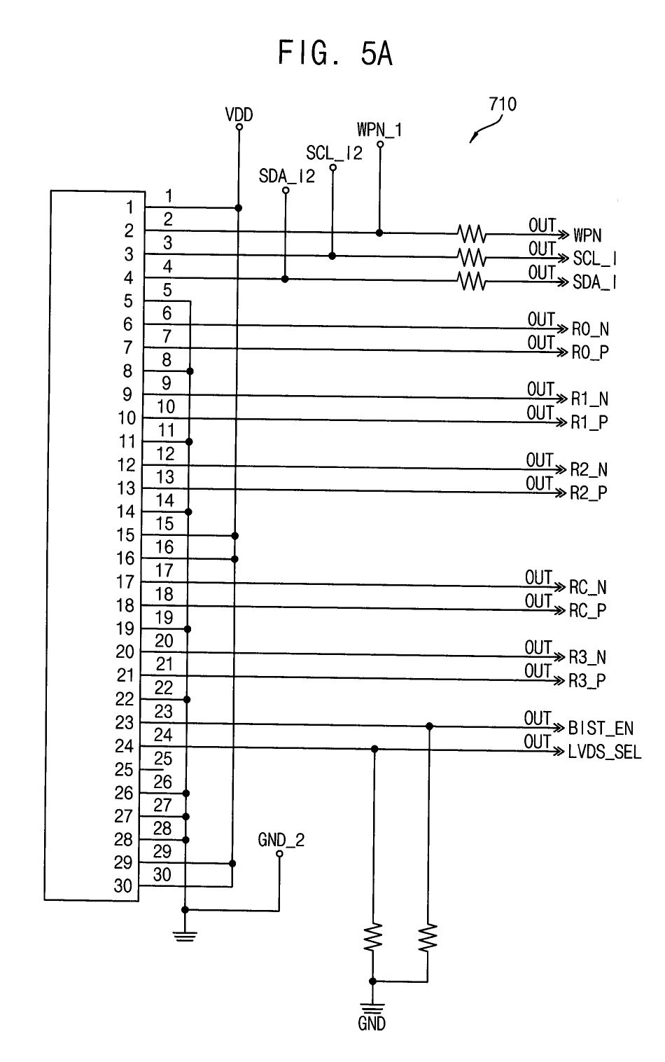

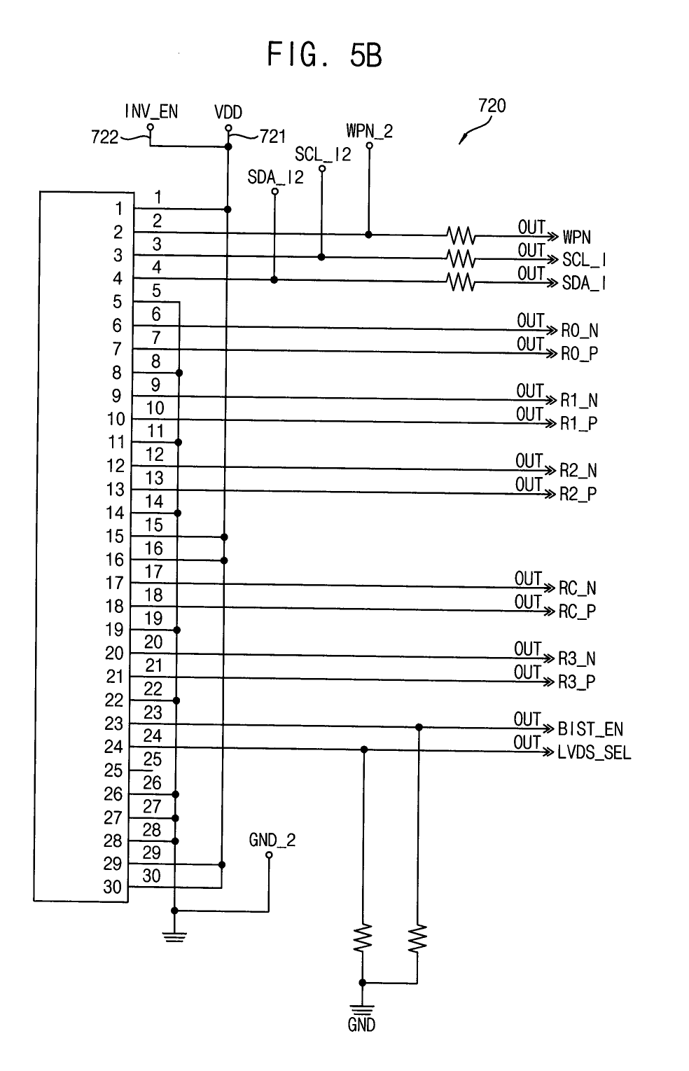

FIG. 4 is a plan view of an alternative exemplary embodiment of a display apparatus according to the invention. FIGS. 5A and 5B are conceptual diagrams illustrating an exemplary embodiment of an input connector of the display apparatus of FIG. 4.

Referring to FIGS. 1, 4, 5A and 5B, an exemplary embodiment of the display apparatus 700 may further include a first input connector 710 for a front screen display mode and second input connector 720 for a rear screen display mode.

In an exemplary embodiment, the first input connector 710 may be disposed in a first side portion of an outer area, e.g., a peripheral area, surrounding a display area of the display apparatus 700. The second input connector 720 may be disposed in a second side portion of the outer area opposite to the first side portion of the display apparatus 700.

In an exemplary embodiment, the first and second input connectors 710 and 720 are selectively connected to an external system in accordance with the front screen mode or the rear screen display mode.

Each of the first and second input connectors 710 and 720 includes a plurality of input terminals, which receives a plurality of signals from the external system, and a plurality of output terminals, which is connected to the timing control part 100. The input and output terminals may be variously designed based on a signal transmission mode.

In one exemplary embodiment, for example, as shown in FIG. 5A, the first input connector 710 receives the digital data DIG_DATA, e.g., a plurality of digital data R0_N, R0_P, R1_N, R1_P, R2_N, R2_P, R3_N, R3_P, RC_N and RC_P, from the external system and transfers the plurality of digital data R0_N, R0_P, R1_N, R1_P, R2_N, R2_P, R3_N, R3_P, RC_N and RC_P to the timing control part 100.

The first input connector 710 receives a plurality of control signals WPN, WPN_{—}1, SCL_I, SDA_I, SCL_I2, SDA_I2, BIST_EN and LVDS_SEL from the external system and transfers the plurality of control signals WPN, WPN_{—}1, SCL_I, SDA_I, SCL_I2, SDA_I2, BIST_EN and LVDS_SEL to the timing control part 100.

The first input connector 710 receives a plurality of power-source signals VDD, GND and GND_{—}2 from the external system and transfers the plurality of power-source signals VDD, GND and GND_{—}2 to the timing control part 100.

In such an embodiment, as shown in FIG. 5A, when the first input connector 710 is connected to the external system, the timing control part 100 of the display apparatus 700 does not receive the screen selection signal INV_EN. Thus, the screen selection signal INV_EN is in the low level LL such that the timing control part 100 controls the display apparatus 700 to drive in the front screen display mode.

In one exemplary embodiment, for example, as shown in FIG. 5B, the second input connector 720 receives the digital data DIG_DATA, e.g., a plurality of digital data R0_N, R0_P, R1_N, R1_P, R2_N, R2_P, R3_N, R3_P, RC_N and RC_P, from the external system and transfers the plurality of digital data R0_N, R0_P, R1_N, R1_P, R2_N, R2_P, R3_N, R3_P, RC_N and RC_P to the timing control part 100.

The second input connector 720 receives a plurality of control signals WPN, WPN_{—}2, SCL_I, SDA_I, SCL_I2, SDA_I2, BIST_EN and LVDS_SEL from the external system and transfers the plurality of control signals WPN, WPN_{—}2, SCL_I, SDA_I, SCL_I2, SDA_I2, BIST_EN and LVDS_SEL to the timing control part 100.

The second input connector 720 receives a plurality of power-source signals VDD, GND and GND_{—}2 from the external system and transfers the plurality of power-source signals VDD, GND and GND_{—}2 to the timing control part 100.

In such an embodiment, the second input connector 720 further include a screen control terminal 722 divided from an output terminal 721 for the power-source signal VDD. The second input connector 720 generates the screen selection signal INV_EN utilizing the power-source signal VDD.

The screen control terminal 722 outputs a screen selection signal INV_EN in a high level HL, which is substantially the same as a voltage level of the power-source signal VDD, and thus the screen selection signal INV_EN is transferred to the timing control part 110.

As shown in FIG. 5B, when the second input connector 720 is connected to the external system, the timing control part 100 of the display apparatus 700 receives the screen selection signal INV_EN. Thus, the screen selection signal INV_EN in the high level HL is applied to the timing control part 100 such that the timing control part 100 controls the display apparatus to drive in the rear screen display mode.

In an exemplary embodiment, as described above, the display apparatus 700 includes the first input connector 710 for the front screen display mode and the second input connector 720 for the rear screen display mode. In such an embodiment, the external system may be selectively connected to the first or second input connector 710 or 720 accordance with the front screen display mode or the rear screen display mode of the display apparatus 700.

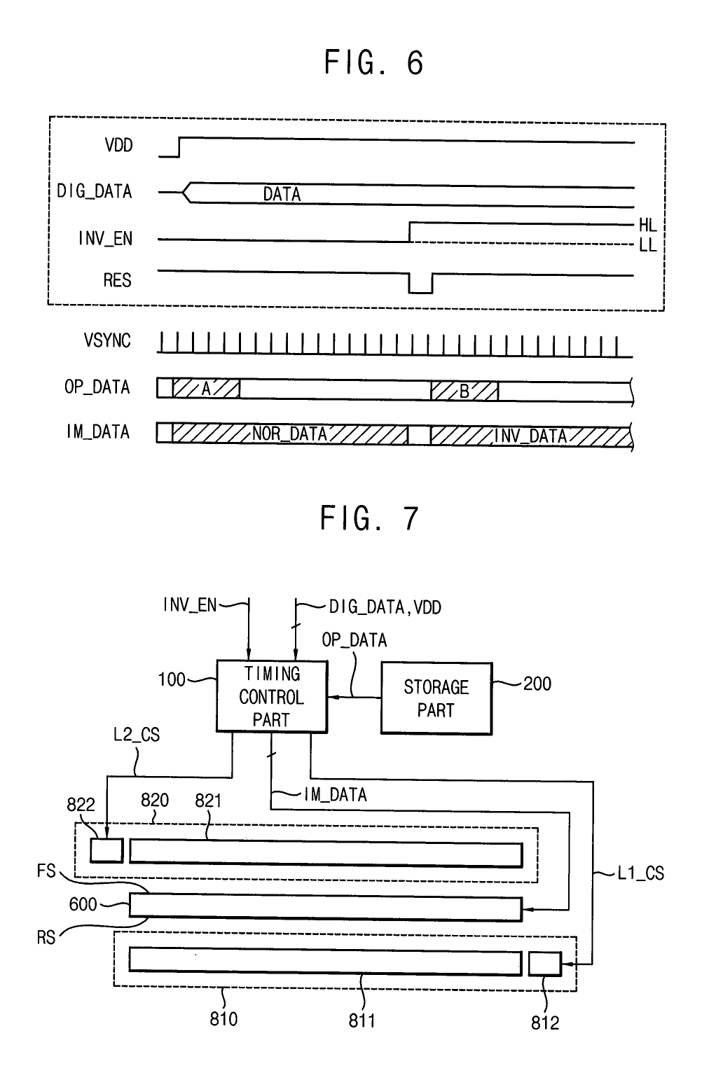

FIG. 6 is a waveform diagram illustrating an exemplary embodiment of input and output signals of the display apparatus, according to invention.

Referring to FIGS. 1 and 6, an exemplary embodiment of a method of driving the display apparatus in the rear screen display mode will hereinafter be described when the screen selection signal corresponding to the rear screen display mode is received via a user interface when the display apparatus is in the front screen display mode.

In the front screen display mode, the timing control part 100 receives digital data DIG_DATA, a power-source signal VDD and a screen selection signal INV_EN in the low level LL.

The timing control part 100 reads out first option data A, which the option data OP_DATA corresponding to the front screen display mode, based on the screen selection signal INV_EN in the low level LL.

The timing control part 100 rearranges the digital data DIG_DATA into first image data NOR_DATA, which is the image data IM_DATA corresponding to the front screen display mode, based on the first option data A and then, outputs the first image data NOR_DATA to the data driving part 400.

Therefore, in such an embodiment, the viewer may normally observe the normal image displayed on the front screen of the display panel 300 from the front view.

In such an embodiment, the timing control part 100 may receive the screen selection signal INV_EN in the high level HL corresponding to the rear screen display mode through the viewer interface.

In such an embodiment, the timing control part 100 receives a reset signal RES in synchronization with the screen selection signal INV_EN in the high level HL. The reset signal RES is a control signal configured to reset a driving of the timing control part 100, that is, a driving of the display module 600.

Thus, when the driving of the timing control part 100 is reset by the reset signal RES, the timing control part 100 reads out second option data B, which is the option data OP_DATA corresponding to the rear screen display mode, from the storage part 200 based on the screen selection signal INV_EN in the high level HL.

The timing control part 100 rearranges the digital data DIG_DATA into second image data INV_DATA, which is the image data IM_DATA corresponding to the rear screen display mode, based on the second option data B and outputs the second image data INV_DATA to the data driving part 400.

Therefore, the viewer may normally observe the normal image displayed on the rear screen of the display panel 300 from a rear view.

In an exemplary embodiment, as described above, the display apparatus may be selectively driven in the front screen display mode or the rear screen display mode in accordance with the screen selection signal received via the user interface.

FIG. 7 is a block diagram illustrating another alternative exemplary embodiment of a display apparatus, according to the invention. Hereinafter, the same reference numerals are used to refer to the same or like parts as those described in the exemplary embodiments described above, and any repetitive detailed description thereof will be simplified or omitted.

Referring to FIG. 7, an exemplary embodiment of the display apparatus 900 includes a timing control part 100, a storage part 200, a display module 600, a first light-source module 810 and a second light-source module 820.

In an exemplary embodiment, the timing control part 100 receives digital data DIG_DATA, a power-source signal VDD and a screen selection signal INV_EN from an external system.

The storage part 200 stores option data OP_DATA corresponding to a driving option item of the display module 600. In one exemplary embodiment, for example, the storage part 200 stores first option data corresponding to a front option item for displaying the normal image on the front screen FS of the display module 600 and second option data corresponding to a rear option item for displaying the normal image on the rear screen RS of the display module 600. In such an embodiment, the storage part 200 may store third option data corresponding to a forward direction mode, which displays the normal image along a first scan direction, and fourth option data corresponding to a reverse direction mode, which displays the normal image along a second scan direction opposite to the first scan direction.

In an exemplary embodiment, the timing control part 100 generates a data control signal DCS and a gate control signal GCS, which are configured to drive the display module 600 based on the option data OP_DATA selected by the screen selection signal INV_EN. In such an embodiment, the timing control part 100 rearranges the digital data DIG_DATA as image data IM_DATA in accordance with a display mode based on the option data OP_DATA and then provides the image data IM_DATA with the display module 600.

In an exemplary embodiment, the timing control part 100 selectively controls to drive the first and second light-source module 810 or 820 based on the screen selection signal INV_EN. In one exemplary embodiment, For example, when the screen selection signal INV_EN is in a low level LL, that is, the display module 600 is driven in the front screen display mode, the timing control part 100 controls the first light-source module 810 such that the first light-source module 810 provides the rear screen RS of the display module 600 with light. In such an embodiment, when the screen selection signal INV_EN is in a high level HL, that is, the display module 600 is driven in the rear screen display mode, the timing control part 100 controls the second light-source module 820 such that the second light-source module 820 provides the front screen FS of the display module 600 with the light.

In such an embodiment, the display module 600 includes a display panel 300, a data driving part 400 and a gate driving part 500, as shown in FIG. 1. The display module 600 includes a front screen FS corresponding to a first screen of the display panel 300 and a rear screen RS corresponding to a second screen opposite to the first screen.

In such an embodiment, the first light-source module 810 is disposed adjacent to the rear screen RS of the display module 600 and provides the rear screen RS of the display module 600 with the light. The first light-source module 810 includes a first light guide plate (“LGP”) 811 and a first light-source 812.

The first LGP 811 may include or be formed by a transparent material and may further include a scattered diffusion agent. The first light-source 812 may be disposed at an edge portion of the first LGP 811.

The second light-source module 820 is disposed adjacent to the front screen FS of the display module 600, and provides the front screen FS of the display module 600 with the light. The second light-source module 820 includes a second LGP 821 and a second light-source 822.

The second LGP 821 may include or formed by a transparent material and may further include a scattered diffusion agent. The second light-source 822 is disposed at an edge portion of the second LGP 821.

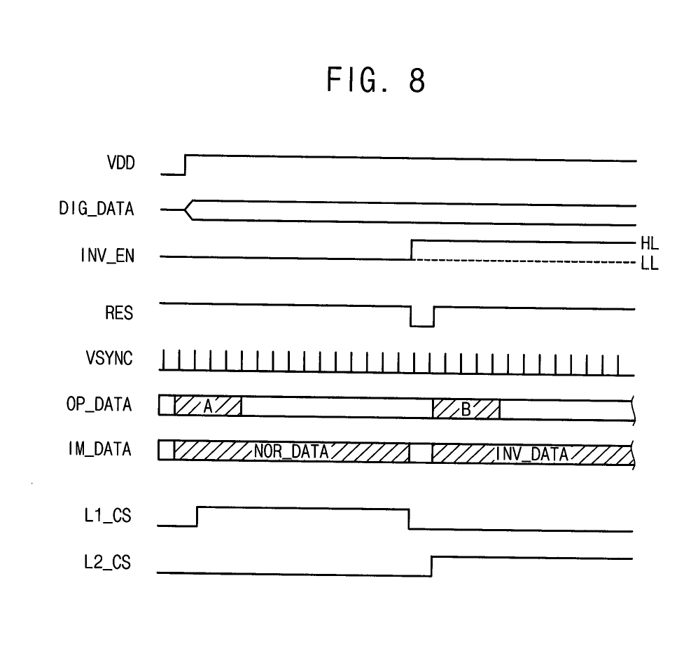

FIG. 8 is a waveform diagram illustrating an exemplary embodiment of input and output signals of the display apparatus of FIG. 7.

Referring to FIGS. 1, 7 and 8, when the display apparatus is in the front screen display mode, the timing control part 100 receives digital data DIG_DATA, a power-source signal VDD and a screen selection signal INV_EN in a low level LL.

The timing control part 100 reads out first option data A, which is the option data OP_DATA corresponding to the front screen display mode, from the storage part 200 based on the screen selection signal INV_EN in the low level LL.

The timing control part 100 rearranges the digital data DIG_DATA into first image data NOR_DATA, which is the image data corresponding to the front screen display mode, based on the first option data A and outputs the first image data NOR_DATA to the data driving part 400.

In an exemplary embodiment, the timing control part 100 provides the first light-source module 810 with a first light-source control signal L1_CS in a high level based on the screen selection signal INV_EN in the low level LL such that the first light-source module 810 emits the light in response to the first light-source control signal L1_CS in the high level. Thus, the first light-source module 810 provides the rear screen RS of the display module 600 with the light. In such an embodiment, the timing control part 100 provides the second light-source module 820 with the second light-source control signal L2_CS in a low level based on the screen selection signal INV_EN in the low level LL such that the second light-source module 820 does not emit the light in response to the first light-source control signal L2_CS in the low level. In such an embodiment, the second light-source control signal L2_CS in the low level turns off the light from the second light-source module 820.

Therefore, in the front screen display mode, the display module 600 displays the normal image on the front screen FS of the display module 600 and the first light-source module 810 provides the rear screen RS of the display module 600 with the light. Thus, the first light-source module 810 drives as a backlight in the front screen display mode.

In such an embodiment, when the display apparatus is in the rear screen display mode, the timing control part 100 receives digital data DIG_DATA, a power-source signal VDD, a reset signal RES and a screen selection signal INV_EN in a high level HL.

The timing control part 100 resets a previous driving for the front screen display mode in synchronization with the reset signal RES, and then reads out second option data B, which is the option data OP_DATA corresponding to the rear screen display mode, from the storage part 200 based on the screen selection signal INV_EN in the high level HL.

The timing control part 100 rearranges the digital data DIG_DATA into second image data INV_DATA, which is the image data IM_DATA corresponding to the rear screen display mode, and then output the second image data INV_DATA to the data driving part 400.

In such an embodiment, the timing control part 100 provides the second light-source module 820 with the second light-source control signal L2_CS in the high level based on the screen selection signal INV_EN in the high level HL such that the second light-source module 820 emits the light in response to the second light-source control signal L2_CS in the high level. Thus, the second light-source module 820 provides the front screen FS of the display module 600 with the light. In such an embodiment, the timing control part 100 provides the first light-source module 810 with the first light-source control signal L1_CS in the low level based on the screen selection signal INV_EN in the high level HL such that the first light-source module 810 does not emit the light in response to the first light-source control signal L1_CS in the low level. In such an embodiment, the first light-source control signal L1_CS in the low level turns off the light from the first light-source module 810.

Therefore, in the rear screen display mode, the display module 600 displays the normal image on the rear screen RS of the display module 600 and the second light-source module 820 provides the front screen FS of the display module 600 with the light. Thus, the second light-source module 820 drives as the backlight in the rear screen display mode.

In an exemplary embodiment, as described above, the display apparatus may include the first and second light-source modules 810 and 820 respectively disposed at both screens of the display module 600, and a display quality may be improved in a low light environment, e.g., in a dark place. In such an embodiment, the display apparatus may selectively display the normal image on both screens of the display module 600 such that the display quality may be improved in a transparent display apparatus.

According to exemplary embodiments of the invention, as set forth herein, a display apparatus may be a transparent display apparatus which includes front and rear screens being all transparent, and the viewer may observe the normal image selectively displayed on the front or rear screen of the transparent display apparatus. Thus, the display quality of the transparent display apparatus may be improved.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of driving a display panel comprising:
receiving a screen selection signal which is configured to select one of a first screen of the display panel, and a second screen of the display panel opposite to the first screen;
selecting one of first option data, which are configured to display a normal image on the first screen, and second option data, which are configured to display the normal image on the second screen, based on the screen selection signal; and
driving the display panel based on the selected one of the first option data and the second option data.

2. The method of claim 1, wherein first image data, which are applied to the display panel based on the first option data, are opposite to second image data, which are applied to the display panel based on the second option data, with respect to left and right sides of the display panel.

3. The method of claim 1, further comprising;
generating the screen selection signal using a power-source signal of the display panel.

4. The method of claim 1, wherein
the first screen of the display panel displays the normal image based on the screen selection signal in a low level, and
the second screen of the display panel displays the normal image based on the screen selection signal in a high level.

5. The method of claim 4, further comprising;
resetting an operation of the display panel in response to a reset signal, when a level of the screen selection signal is changed.

6. The method of claim 4, further comprising:
providing the second screen of the display panel with light in response to the screen selection signal in the low level; and
providing the first screen of the display panel with the light in response to the screen selection signal in the high level.

7. A display apparatus comprising:
a display panel comprising a first screen, and a second screen opposite to the first screen;
a storage part which stores first option data, which are configured to display a normal image on the first screen, and second option data, which are configured to display the normal image on the second screen; and
a timing control part which receives a screen selection signal, which is configured to select one of the first and second screens of the display panel, and drives the display panel using one of the first option data and the second option data,
wherein the one of the first option data and the second option data is selected based on the screen selection signal.

8. The display apparatus of claim 7, further comprising:
a data driving part configured to provide the display panel with image data,
wherein the data driving part provides the display panel with first image data based on the first option data and provides the display panel with second data based on the second option data, and
the second data is opposite to the first data with respect to left and right sides of the display panel.

9. The display apparatus of claim 7, further comprising:
a first input connector disposed at a first side portion of the display panel and configured to receive an external signal; and
a second input connector disposed at a second side portion of display panel opposite to the first side portion and configured to receive the external signal.

10. The display apparatus of claim 9, wherein one of the first and second input connectors generates the screen selection signal using the external signal.

11. The display apparatus of claim 9, wherein the external signal is a power-source signal.

12. The display apparatus of claim 11, wherein the screen selection signal has a level substantially same as a level of the power-source signal.

13. The display apparatus of claim 7, wherein the screen selection signal is received via a user interface.

14. The display apparatus of claim 7, wherein the first screen of the display panel displays the normal image in response to the screen selection signal in a low level, and
the second screen of the display panel displays the normal image in response to the screen selection signal in a high level.

15. The display apparatus of claim 14, wherein the timing control part resets an operation of the display panel in response to a reset signal, when a level of the screen selection signal is changed.

16. The display apparatus of claim 14, further comprising:
a first light-source module disposed adjacent to the second screen and configured to provide the second screen with light; and
a second light-source module disposed adjacent to the first screen and configured to provide the first screen with light.

17. The display apparatus of claim 16, wherein each of the first and second light-source modules comprises:
a transparent light guide plate; and
a light-source disposed at an edge portion of the transparent light guide plate.

18. The display apparatus of claim 16, wherein the timing control part is configured to control an operation of the first and second light-source modules based on the screen selection signal.

19. The display apparatus of claim 18, wherein the first light-source module provides the second screen of the display panel with the light, when the first screen of the display panel displays the normal image.

20. The display apparatus of claim 18, wherein the second light-source module provides the first screen of the display panel with the light, when the second screen of the display panel displays the normal image.
